(19) United States
(12) Patent Application Publication
(10) Pub. No.: US 2003/0044134 A1
(43) Pub. Date: Mar. 6, 2003

(54) Optical sub-assembly package

(76) Inventor: William J. Strachan, Somerset, NJ (US)

Correspondence Address: Jeff Klembczyk, JDS Uniphase Corporation, Intellectual Property Dept., 570 West Hunt Club Road, Nepean, ON, K2G 5W8, CA

(21) Appl. No.: 10/209,886

(22) Filed: Aug. 2, 2002

Related U.S. Application Data
(60) Provisional application No. 60/316,430, filed on Aug. 31, 2001.

(51) Int. Cl. G02B 6/42

(52) U.S. Cl. 385/93; 385/92

(57) ABSTRACT

The invention relates to an optical sub-assembly package as well as a method of manufacturing the optical sub-assembly package. The optical sub-assembly package according to the present invention can be broken down into two distinct sub-sections, a waveguide assembly and an optical assembly. The waveguide assembly includes an optical fiber, with a ferrule on one end thereof, fixed to a GRIN lens. The optical assembly includes a transducer, e.g. a photodiode, for converting between electrical and optical signals. The waveguide assembly is mounted in a mounting sleeve, while the optical assembly is mounted in a housing. During the manufacturing process the waveguide assembly can be moved in the z-axis away from the optical assembly within the mounting sleeve, and moved in the x-y plane along with the mounting sleeve. By positioning the waveguide assembly outside of the housing, many of the problems inherent in the prior art assemblies, i.e. hermeticity and misalignment, are avoided. Moreover, the precision required to mount the optical sub-assemblies within the housing is no longer necessary, resulting in the ability of the manufacturing process to become fully automated.

### CROSS-REFERENCE TO RELATED APPLICATIONS

The present application claims priority from U.S. patent application Ser. No. 60/316,430 filed Aug. 30, 2001.

### TECHNICAL FIELD

The present invention relates to an optical sub assembly package and a process for manufacturing an optical sub-assembly package, and in particular to a process for manufacturing an optical sub-assembly package that is compatible with automated assembly techniques.

### BACKGROUND OF THE INVENTION

In conventional optical sub-assembly package manufacturing processes, such as the one disclosed in U.S. Pat. No. 4,119,363 issued Oct. 10, 1978 to Irfan Camlibel et al, an optical fiber is directly aligned with the active area of a photodiode. Unfortunately, this approach involves passing the fiber through the wall of the housing, and hermetically sealing all the way around the gap therebetween. Moreover, this process involves actively or passively aligning the fiber within 10 to 50 microns of the photodiode without additional optics to condition the light. Passive alignment systems, such as the one disclosed in U.S. Pat. No. 5,896,481 issued Apr. 20, 1999 to Mark Beranek et al, typically require specially designed micro-benches and metallized fibers for mounting thereon These processes are very labor intensive, usually including several manual process steps, and requires extremely precise manipulation of the elements within the housing.

To eliminate some of the problems inherent in the aforementioned process, a lens can be mounted between the optical fiber and the optical sub-assembly as disclosed in U.S. Pat. No. 4,945,400 issued Jul. 31, 1990 in the name of Greg Blonder et al. Unfortunately, the addition of a lens inside the housing does not eliminate the need for high precision alignment of the optical sub-assembly with the lens within the confines of the housing.

Another possible approach which alleviates some of the alignment problems is to use a fiber with an integrated lens on the end thereof, which is disclosed in U.S. Pat. No. 5,101,457 issued Mar. 31, 1992 to Greg Blonder et al. However, since the light usually focuses very close to the integrated lens (˜50 microns), the fiber still must be positioned very close to the optical sub-assembly, which limits the design choices as there is only one optical surface to condition the light.

Some optical sub-assembly package designs alleviate many of the aforementioned problems by positioning the fiber outside the housing, and optically coupling the fiber to a lens embedded in the housing wall. Unfortunately, because the lens in not visible, alignment of the lens with the optical sub-assembly becomes very difficult, even for computer controlled techniques.

An object of the present invention is to alleviate the shortcomings of the prior art by providing an optical sub-assembly, which does not require any of the optical components to extend through the housing.

Another object of the present invention is to provide an optical sub-assembly that can be manufactured using a fully automated process.

Another object of the present invention is to facilitate the manufacturing process by combining the fiber and the lens into a single assembly for alignment purposes, thereby greatly reducing the precision required to mount the optical sub-assembly within the housing.

### SUMMARY OF THE INVENTION

Accordingly, the present invention relates to an optical sub-assembly package comprising:

a transducer for converting an optical signal into an electrical signal or for converting an electrical signal into an optical signal;

a housing for supporting the transducer, the housing including a window transparent to the optical signal;

a waveguide for conveying an optical signal to or from the housing, the waveguide having a ferrule encasing one end thereof;

a first lens connected to the ferrule forming a waveguide assembly, the first lens for directing the optical signal towards the transducer or for focusing the optical signal onto the waveguide; and

a mounting sleeve receiving the waveguide assembly and fixed thereto, the mounting sleeve connected to the housing at an area around the window.

Another aspect of the present invention relates to a method of manufacturing an optical sub-assembly package comprising the steps of:

a) mounting an optical sub-assembly, which is for converting an optical signal into an electrical signal or vice versa, within a housing, which includes electrical contacts and a window transparent to the optical signal;

b) connecting electrical contacts on optical sub-assembly to the electrical contacts on housing;

c) providing a waveguide assembly including: an optical fiber, having one end encased in a ferrule; and a lens fixed to the ferrule;

d) providing a mounting sleeve for receiving at least a portion of the waveguide assembly;

e) aligning the waveguide assembly with the optical sub-assembly with the window therebetween by abutting the mounting sleeve with the waveguide assembly therein against the housing;

f) moving the mounting sleeve in a plane parallel to the transparent window, and moving the waveguide assembly in a direction perpendicular to the transparent window until the a desired level of optical coupling is reached between the optical subassembly and the waveguide assembly;

g) fixing the waveguide assembly to the mounting sleeve; and

h) fixing the mounting sleeve to the housing.

### BRIEF DESCRIPTION OF THE DRAWINGS

The invention will be described in greater detail with reference to the accompanying drawings which represent preferred embodiments thereof, wherein:

FIG. 1 is a partly sectioned isometric view of an optical sub-assembly according to the present invention;

FIG. 2 is a partly sectioned isometric view of another embodiment of the present invention;

FIG. 3 is a cross-sectional view of the optical sub-assembly of FIG. 2; and

FIG. 4 is a partly sectioned isometric view of another embodiment of the present invention.

### DETAILED DESCRIPTION

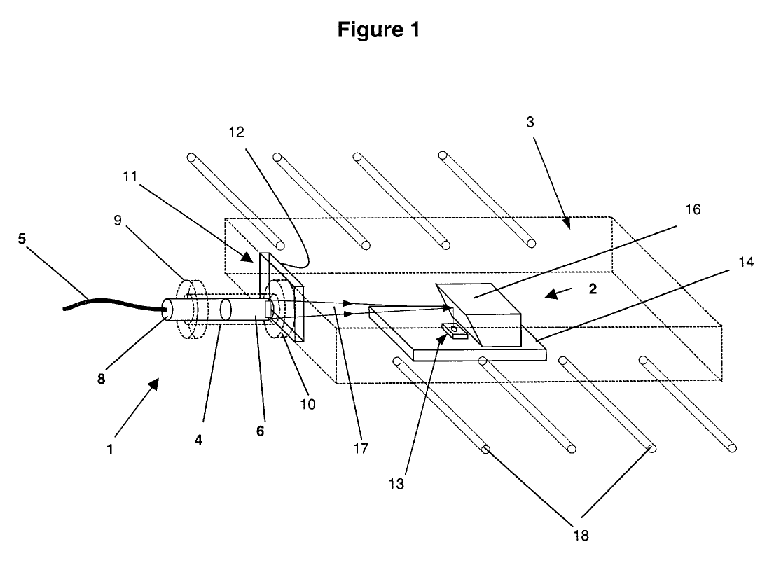

The embodiment of the present invention illustrated in FIG. 1 includes a waveguide assembly, generally indicated at 1, an optical assembly, generally indicated at 2, a housing 3, and a mounting sleeve 4.

The waveguide assembly 1 includes an optical fiber 5 and a lens 6. Typically, one end of the optical fiber 5 is encased in a ferrule 8. Preferably, the lens 6 is a graded index (GRIN) lens, which is fixed to the ferrule 8 for movement as a single unit during the alignment process. Other types of lenses can be used, such as ball lenses or aspherical lenses. Aberrations due to misalignment of the fiber and the optic axis of the lens are eliminated, because the fiber and lens move together. Furthermore, displacement magnification effects of the lens are also eliminated, i.e. the position of the focused spot moves with the position of the waveguide assembly on a 1:1 basis. Preferably, the ferrule 8 extends outwardly from the outer free end of the mounting sleeve 4 to be grasped by a manual or automated tool, which enables the position of the lens 6 and ferrule 8 to be easily adjusted relative to the mounting sleeve 4, i.e. in the Z-direction, without pulling on the fiber 5. Annular flanges 9 and 10 are provided on the mounting sleeve 4 to facilitate adjustment thereof with the waveguide assembly 1 relative to the optical assembly 2, i.e. in the X-Y directions by a manual or automated grasping tool. The flange 10 abuts against the area around the window 11 providing a more stable base and an easily accessible welding joint.

The housing 3 is a conventional two-piece rectangular housing including a window 11, which is transparent to the light passing therethrough. For hermetic applications, the window 11 is covered by a solid transparent block 12, e.g. glass, which is soldered or fixed with other suitable adhesive techniques to an inside wall of the housing 3 surrounding the window 11, so that a corresponding area on an outside surface of the housing 3 surrounding the window 11 is undisturbed. The area surrounding the window 11 on the outside wall of the housing 3 is made of a material suitable for fixing one of the flanges 9 of the mounting sleeve 4 thereto. Since laser welding is a preferred fixation method, some form of suitable metal is obviously preferred. Manufacturing the mounting sleeve 4 and the housing 3 entirely out of a suitable metal would be preferable; however, other arrangements are possible.

In the embodiment illustrated in FIG. 1, the optical assembly 2 includes a lensed photodiode flip chip 13 bonded to a silicon micro-bench 14. A reflective surface 16 redirects an optical beam 17 focused by the lens 6 onto the photodiode 13. Electrical leads 18, which are electrically connected to leads on the micro-bench 14, extend outwardly from the housing 3 for connection with electrical contacts (not shown) remote from the device.

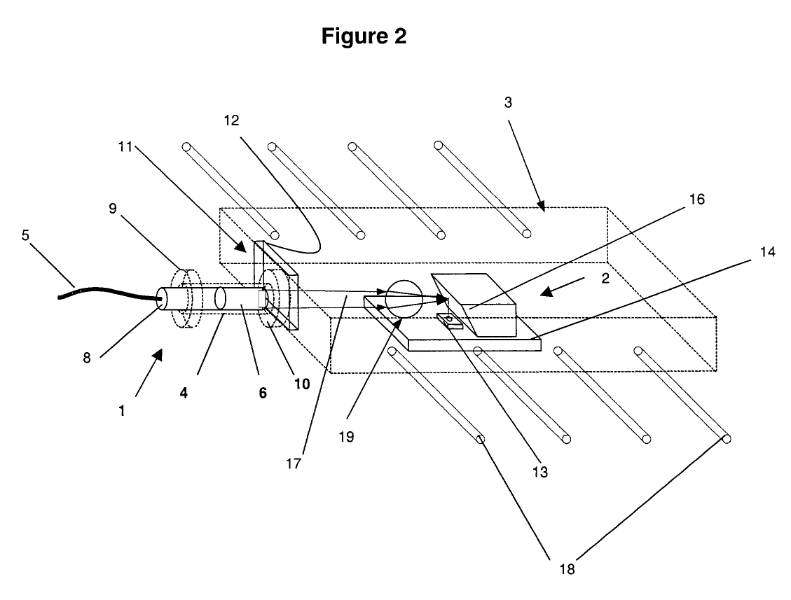

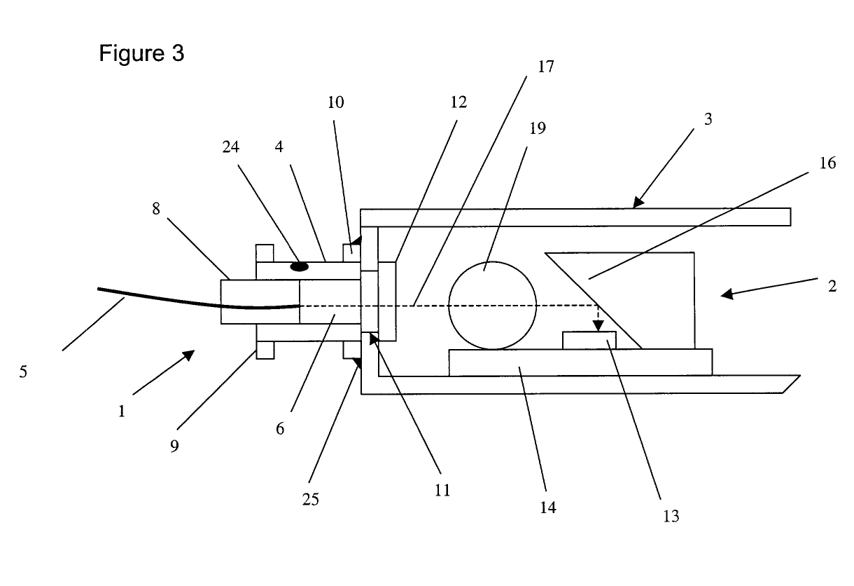

In the embodiment illustrated in FIGS. 2 and 3, the lens 6 collimates the beam 17, and an additional lens, e.g. a ball lens 19, focuses the beam 17 onto the photodiode 13. The ball lens 19 and the lens etched into the photodiode 13 act like a telescope to simplify optical coupling.

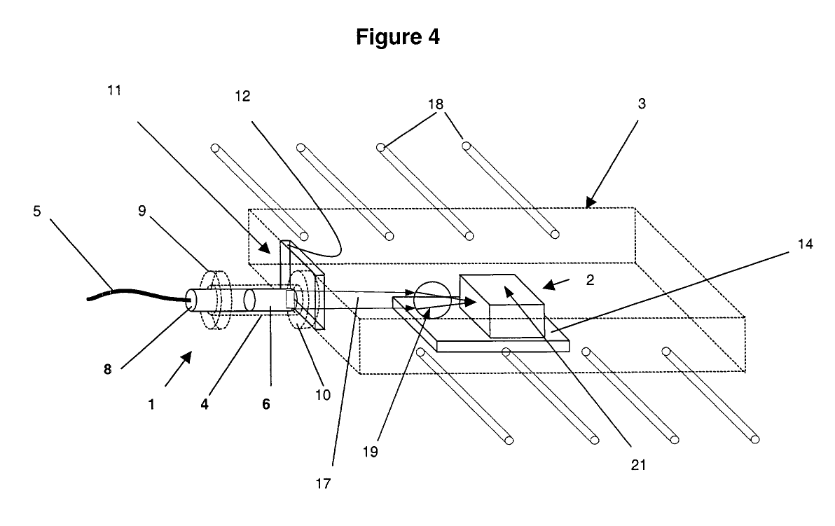

In the embodiment illustrated in FIG. 4, the flip chip photodiode 13 is replaced by a waveguide photodiode 21. Accordingly, the ball lens 19 optically couples the light into the waveguide photodiode 21.

The optical sub-assemblies in the illustrated embodiments include a photodiode; however, it would be possible to use another form of transducer in the present invention, such as a laser diode, for converting between electrical and optical signals.

One major advantage of the present invention is the placement tolerance of the optical assembly 2 is only limited (optically) by the size of the window 11. The optical axis of the waveguide assembly can be move to meet the optical axis of the optical assembly anywhere within the limits of the housing window 11. Accordingly, the placement tolerance of the optical assembly is in the order of millimeters instead of microns.

The assembly process according to the present invention begins with the assembly of the optical assembly 2, which can be done with known, preferably automated, techniques. Next, the optical assembly 1 is mounted within a housing 3 using a low precision machine, and the electrical contacts on the optical assembly 2 are bonded to the electrical contacts 18 on the housing 3. Optionally, the solid transparent block 12 would have already been mounted to the inside surface of the housing 3 over the window 11 using glass solder or some other suitable technique. The ferrule 8 with the lens 6 connected thereto, i.e. the waveguide assembly, are then slid into the mounting sleeve 4. The mounting sleeve 4 is brought into contact with the area surrounding the window 11 on the outside surface of the housing 3. A series of iterative alignment steps are conducted in which the waveguide assembly 1 and the mounting sleeve 4 are moved in the x-y plane parallel to the window 11, and the waveguide assembly 1 is moved along the z-axis within the mounting sleeve 4. This process can be any suitable alignment method, as known in the industry. When coupling efficiency between the fiber 5 and the photodiode 16 has reached a predetermined threshold, the lens 6 and ferrule 8 are fixed to the mounting sleeve 4, preferably with laser welds 24 using a laser welder. Then, the mounting sleeve 4 is fixed to the housing 3, preferably with laser welds or solder 25 using a laser welder or soldering device. Of course, the last two fixing steps could be done in any order or simultaneously. For hermetic applications, the housing 3 would then be sealed up tight.

The modular construction of the optical sub-assembly package according to present invention is compatible with existing high-speed fully automated, commercially available assembly equipment. Moreover, space inside the housing 3 can be minimized, as excess space normally required to accommodate a fiber gripping tool is not required with the waveguide assembly 1 mounted outside the housing 3.

We claim:

1. An optical sub-assembly package comprising:
a transducer for converting an optical signal into an electrical signal or for converting an electrical signal into an optical signal;
a housing for supporting the transducer, the housing including a window transparent to the optical signal;
a waveguide for conveying an optical signal to or from the housing, the waveguide having a ferrule encasing one end thereof;
a first lens connected to the ferrule forming a waveguide assembly, the first lens for directing the optical signal towards the transducer or for focusing the optical signal onto the waveguide; and
a mounting sleeve receiving the waveguide assembly and fixed thereto, the mounting sleeve connected to the housing at an area around the window.

2. The package according to claim 1, wherein a portion of the housing, which surrounds the transparent window, is metal; wherein the mounting sleeve is metal; and wherein the mounting sleeve is welded or soldered to the housing.

3. The package according to claim 2, wherein the transparent window includes a solid material, transparent to the optical signal, mounted on the inside of the housing over an opening in the housing.

4. The package according to claim 1, further comprising a second lens mounted inside the housing for directing the optical signal between the optical sub-assembly and the waveguide assembly.

5. The package according to claim 4, wherein the optical sub-assembly is a photodiode; and wherein the second lens is etched into a surface of the photodiode.

6. The package according to claim 1, wherein the first lens is a graded index lens.

7. The package according to claim 1, wherein the waveguide assembly extends outwardly from one end of the mounting sleeve for grasping during alignment.

8. The package according to claim 1, wherein the mounting sleeve includes a first flange on one end thereof for abutting the area around the window.

9. The package according to claim 8, wherein the mounting sleeve includes a second flange on another end thereof for facilitating grasping during alignment thereof.

10. A method of manufacturing an optical sub-assembly package comprising the steps of:
a) mounting an optical sub-assembly, which is for converting an optical signal into an electrical signal or vice versa, within a housing, which includes electrical contacts and a window transparent to the optical signal;
b) connecting electrical contacts on optical sub-assembly to the electrical contacts on housing;
c) providing a waveguide assembly including: an optical fiber, having one end encased in a ferrule; and a lens fixed to the ferrule;
d) providing a mounting sleeve for receiving at least a portion of the waveguide assembly;
e) aligning the waveguide assembly with the optical sub-assembly with the window therebetween by abutting the mounting sleeve with the waveguide assembly therein against the housing;
f) moving the mounting sleeve in a plane parallel to the transparent window, and moving the waveguide assembly in a direction perpendicular to the transparent window until the a desired level of optical coupling is reached between the optical subassembly and the waveguide assembly;
g) fixing the waveguide assembly to the mounting sleeve; and
h) fixing the mounting sleeve to the housing.

11. The method according to claim 1, wherein step g) comprises laser welding the waveguide assembly to the mounting sleeve.

12. The method according to claim 1, wherein step h) comprises laser welding or soldering the mounting sleeve to the housing.

13. The method according to claim 1, wherein step a) includes mounting a solid transparent material on the inside of the housing over the transparent window.

14. The method according to claim 13, wherein step a) further includes hermetically sealing the optical sub-assembly in the housing.

15. The method according to claim 10, wherein step g) includes:
grasping one end of the waveguide assembly, which extends outwardly from the mounting sleeve, and moving the waveguide assembly relative to the mounting sleeve in a direction substantially perpendicular to the window.

16. The method according to claim 15, wherein step g) further includes:
grasping the mounting sleeve, and moving the mounting sleeve with the waveguide assembly therein in a direction substantially parallel to the window.
